(19) United States
(12) Patent Application Publication
(10) Pub. No.: US 2013/0086311 A1
(43) Pub. Date: Apr. 4, 2013

(54) METHOD OF DIRECT CONNECTING AHCI OR NVMe BASED SSD SYSTEM TO COMPUTER SYSTEM MEMORY BUS

(71) Applicants: Ming Huang, Thousand Oaks, CA (US); Zhiqing Zhuang, Irvine, CA (US)

(72) Inventors: Ming Huang, Thousand Oaks, CA (US); Zhiqing Zhuang, Irvine, CA (US)

(21) Appl. No.: 13/629,642

(22) Filed: Sep. 28, 2012

Related U.S. Application Data
(63) Continuation-in-part of application No. 11/953,080, filed on Dec. 10, 2007, now abandoned.

(51) Int. Cl. G06F 13/16

(52) U.S. Cl. CPC G06F 13/1689
USPC 711/103

(57) ABSTRACT

A SSD system directly connected to the system memory bus includes at least one system memory bus interface unit, one storage controller with associated data buffer/cache, one data interconnect unit, one nonvolatile memory (NVM) module, and flexible association between storage commands and the NVM module. A logical device interface, the Advanced Host Controller Interface (AHCI) or NVM Express (NVMe), is used for the SSD system programming. The SSD system appears to the computer system physically as a dual-inline-memory module (DIMM) attached to the system memory controller, and logically as an AHCI device or an NVMe device. The SSD system may sit in a DIMM socket and scaling with the number of DIMM sockets available to the SSD applications. The invention moves the SSD system from I/O domain to the system memory domain.

### CROSS REFERENCE TO RELATED APPLICATIONS

The present application is a continuation-in-part of U.S. patent application Ser. No. 11/953,080, filed on Dec. 10, 2007, which claims the benefit of U.S. Provisional Application No. 60/875,316 entitled “Nonvolatile memory (NVM) based solid-state disk (SSD) system for scaling and quality of service (QoS) by parallelizing command execution” filed Dec. 18, 2006, which is herein incorporated by reference.

### BACKGROUND OF THE INVENTION

1. Field of the Invention

The present invention is directed in general to the field of computer storage system. In one aspect, the present invention relates to an AHCI or an NVMe based SSD system which is directly connected to the system memory bus.

2. Description of the Related Art

PCIe SSDs have become extremely popular in a very short amount of time. They provide uncomplicated access to high performance storage, allowing latency problems to be significantly reduced on the server where the application is run. The problem with PCIe SSDs is that they require space in the server and can cause potential cooling problems. They also consume not insignificant amounts of power; consume CPU cycles to gain maximum performance.

A SATADIMM, produced by Viking Modular Solutions, resides in the DIMM memory slot of a motherboard to take advantage of spare DIMM memory slots for drawing power. However, I/O operations such as, data transfers to and from a SATADIMM is by way of a SATA cable connected to the SATADIMM, which does not take advantage of the significantly higher bandwidth of the main memory bus for I/O operations.

Many servers may have available DIMM slots since it is simply too expensive to fill them up with maximum capacity DRAM modules. DIMM-based SSD technology should be looked at as a serious alternative to expensive high capacity DRAM. Since a single SSD DIMM provides far inure capacity than DRAM DIMM can, the system can then use this storage as a cache or paging area for DRAM operations.

Therefore, there exists a need for a SSD system and method to provide similar performance to PCIe SSDs, and take the advantages of the SATADIMM, which will be directly connected to the system memory bus as an alternative to expensive high capaci DRAM.

### SUMMARY OF THE INVENTION

A SSD system directly connected to the system memory bus is disclosed. A SSD system includes at least one system memory bus interface unit, one storage controller with associated shared system memory as its data buffer/cache, one data interconnect unit, one nonvolatile memory module, and flexible association between AHCI/NVMe commands and the nonvolatile memory module. A logical device interface, the Advanced Host Controller Interface or NVM Express, is used for the SSD system programming, which makes the SSD appear to the system as a SATA SSD or an NVMe SSD.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of the functional components of a typical SSD system of the present invention, which may be plugged in a DIMM socket.

FIG. 2 shows a block diagram of the logic view of a scalable storage system of the present invention in multiple DIMM sockets.

FIG. 3 shows a block diagram of a system memory bus interface unit which includes a DDR3/DDR4 controller and an AHCI/NVMe controller.

FIG. 4 shows a block diagram of the command processor including a RX command queue module, a TX command queue module, and a storage command classifier module.

FIG. 5 shows a block diagram of the media processor including a channel address lookup module, and a Microprocessor module.

FIG. 6 shows a block diagram of the channel processor including an ECC engine, data randomizer, and NVM interface controller.

FIG. 7 shows a schematic block diagram of a nonvolatile memory system with multiple flash modules.

FIG. 8 shows a schematic block diagram of a nonvolatile memory channel processor.

FIG. 9 shows a schematic block diagram of an AHCI SSD on a DIMM form factor with interrupt pin to the host.

FIG. 10 shows a schematic block diagram of an NVMe SSD on a DIMM form factor with interrupt pin to the host.

FIG. 11 shows a schematic block diagram of an NVMe SSD system with an ASIC controller on the mother board to control multiple DDR3/DDR4 DIMMs and NVM DIMMs.

FIG. 12 shows a schematic block diagram of an NVMe SSD system with multiple NVMe SSD on DIMMs.

### DETAILED DESCRIPTION OF ILLUSTRATIVE EMBODIMENTS

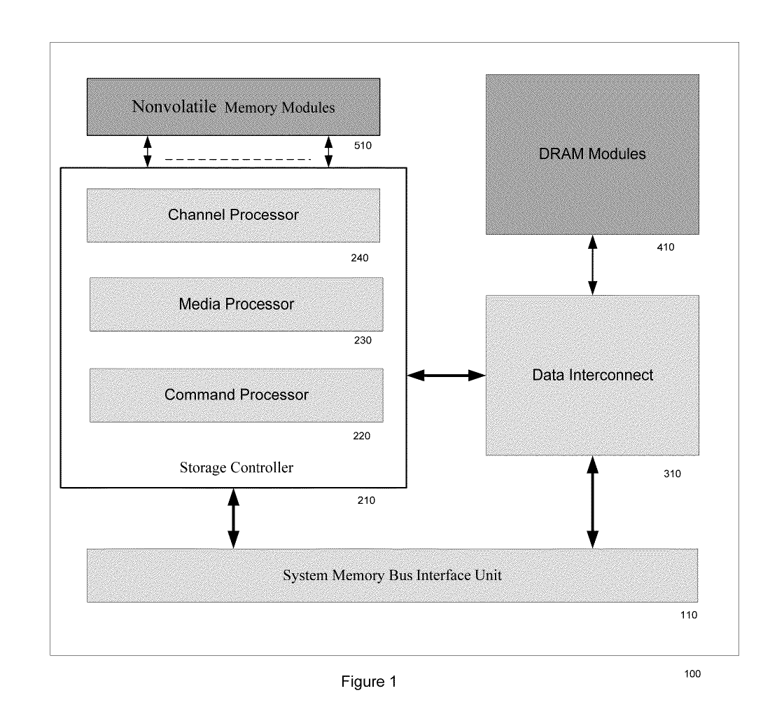

Referring to FIG. 1, a block diagram of a SSD subsystem 100 is shown. More specifically, the SSD 100 includes a system memory bus interface unit 110, a storage processor 210, a data interconnect unit 310, a DRAM module 410, and a NVM module 510. The storage controller 210 further includes a command processor 220, a media processor 230, and a channel processor 240,

The SSD system 100 enables scaling by parallelizing the system memory bus interface and associated processing. The storage system 100 is applicable to more than one interface simultaneously. The storage system 100 provides a flexible association between command quanta and processing resource. The storage system 100 is partitionable, and thus includes completely isolated resource per unit of partition. The storage system 100 is virtualizable.

The storage system 100 includes a flexible non-strict classification scheme. Classification is performed based on command types, destination address, and requirements of QoS. The information used in classification is maskable and programmable. The storage command classification includes optimistically matching command execution orders during the non-strict classification to maximize system throughput. The storage system includes providing a flow table format that supports both exact command order matching and optimistic command order matching.

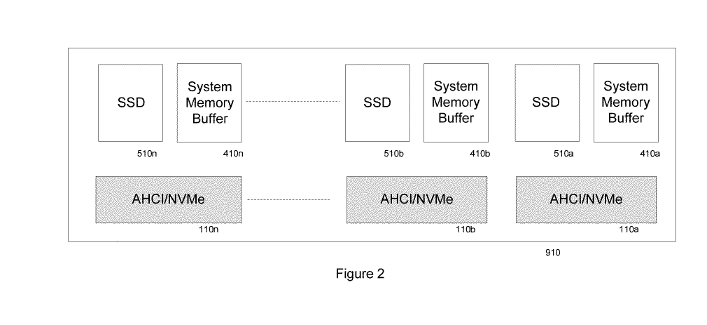

Referring to FIG. 2, a block diagram of a logic view of the SSD system 100 is shown. The SSD system includes multiple SSD modules. Each SSD module has an AHCI/NVMe controller inside the BIU 110, shared system memory buffer 410, and dedicated NVM. Each SSD module appears to the system as a SATA or NVMe SSD. The SSD system supports virtualization and RAID features.

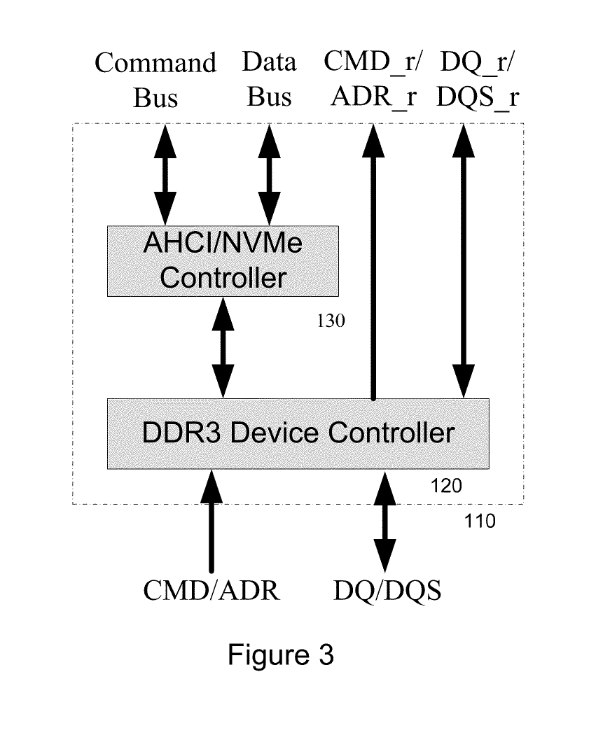

Referring to FIG. 3, a block diagram of a system memory bus interface unit 110 is shown. The BIU 110 includes a DDR3/DDR4 device controller 120, and an AHCI/NVMe controller 130. The DDR3/DDR4 device controller 120 is used to buffer and interpret CMD/ADDR, and send it to the AHCI/NVMe controller 130 and data interconnect module 310. The DDR3/DDR4 device controller 120 also controls the data transfer to and from the AHCI/NVMe controller 130 and data interconnect module 310. The AHCI/NVMe controller 130 performs the functions as specified by the AHCI Specification or the NVMe Specification.

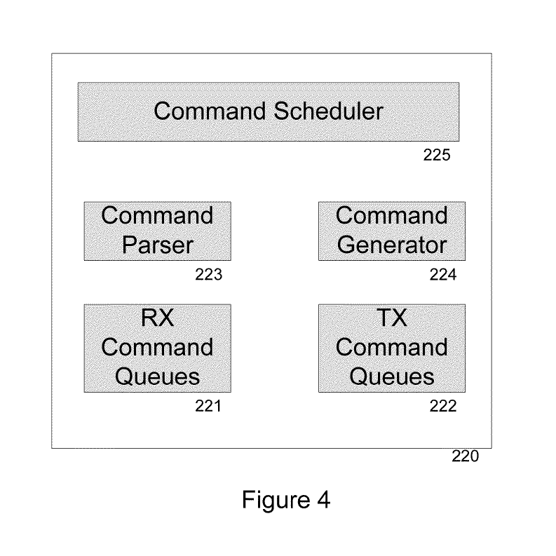

Referring to FIG. 4, a block diagram of a command processor 220 is shown. The command processor 220 includes the RX command queues 221, the TX command queues 222, the command parser 223, the command generator 224, and the command scheduler 225.

The RX command queues 221 receive SATA or NVMe commands Storage commands received by the module are sent to the command parser 223.

The command parser 223 classifies the RX commands based on the type of command, the LBA of the target media, and the requirements of QoS. The command parser also terminates commands that are not related to the media read and write.

The command generator 224 generates the TX commands based on the requests from either the command parser 223 or the media processor 230. The generated commands are posted to the TX command queue 222 based on the tag and type of the corresponding RX command.

The command scheduler module 225 includes a strict priority (SP) scheduler module, a weighted round robin (WRR) scheduler module as well as a round robin (RR) scheduler module. The scheduler module serves the storage Interface Units within the storage interface subsystem 110 in either WRR scheme or RR scheme. For the commands coming from the same BIU, the commands shall be served based on the command type and target LBA. The NCQ commands are served strictly based on the availability of the target channel processor. When multiple channel processors are available, they are served in RR scheme. For the non-NCQ commands, they are served in FIFO format depending on the availability of the target channel processor.

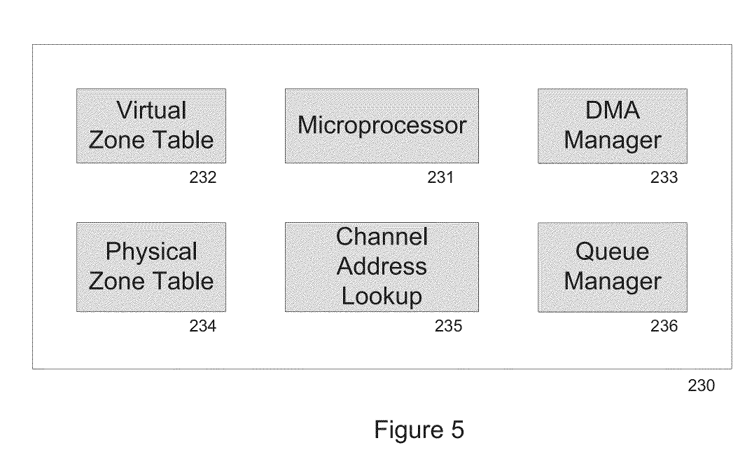

Referring to FIG. 5, a block diagram of a media processor 230 is shown. The media processor 230 includes a channel address lookup table 235 for command dispatch. The module also includes hardware and firmware for media management and command executions. The module is coupled to the system memory bus interface unit 110 via the DMA manager 233. The module is also coupled to the command processor module 220 via the command scheduler 225. The module is also coupled to the channel processor module 230 via the DMA manager 233, and the queue manager 236.

The media processor 230 includes a Microprocessor module 231, Virtual Zone Table module 232, a Physical Zone Table 234, a Channel Address Lookup Table 235, a DMA Manager module 233, and a Queue Manager module 236.

The Microprocessor module 231 includes one or more microprocessor cores. The module may operate as a large simultaneous multiprocessing (SMP) system with multiple partitions. One way to partition the system is based on the Virtual Zone Table. One thread or one microprocessor core is assigned to manage a portion of the Virtual Zone Table. Another way to partition the system is based on the index of the channel processor. One thread or one microprocessor core is assigned to manage one or more channel processors.

The Virtual Zone Table module 232 is indexed by host logic block address (LBA). It stores of entries that describe the attributes of every virtual strip in this zone. One of the attributes is host access permission that is capable to allow a host to only access a portion of the system (host zoning). The other attributes include CacheIndex that is cache memory address for this strip if it can be found in cache; CacheState is to indicate if this virtual strip is in the cache; CacheDirty is to indicate which modules cache content is inconsistency with flash; and FlashDirty is to indicate which modules in flash have been written. All the cache related attributes are managed by the Queue Manager module 236.

The Physical Zone Table module 234 stores the entries of physical NVM blocks and also describe the total lifetime flash write count to each block and where to find a replacement block in case the block goes bad. The table also has entries to indicate the corresponding LBA in the Virtual Zone Table.

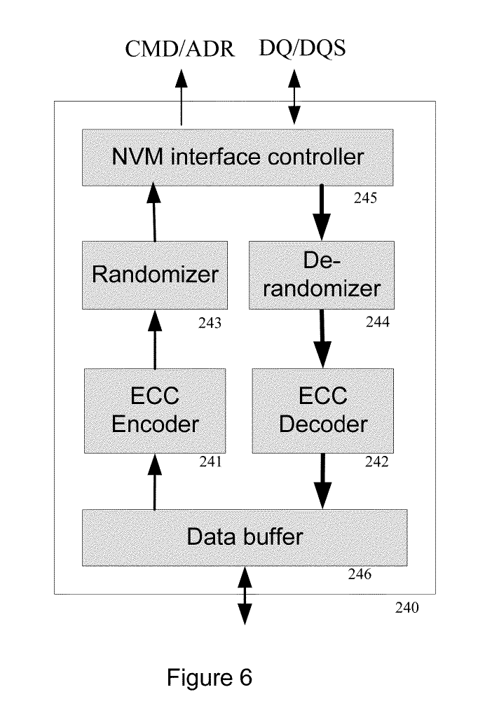

Referring to FIG. 6, a block diagram of a channel processor 240 is shown. The channel processor module 240 includes multiple storage channel processor. Storage data received by the module are sent to the data buffer 246. The media processor 230 arms the DMA manager 233 to post the data to the DRAM module 410 via the interconnect module 310. Transmit storage data are posted to the data buffer 246 via the interconnect module 310 using DMA manager 233.

The channel processor 240 also supports data randomization using randomizer 243 and de-randomization using de-randomizer 244. The module performs CRC check on both receive and transmit data paths via the ECC encoder 241 and ECC decoder 242, respectively. The module controls the NVM interface timing, and access command sequences via the NVM interface controller 245.

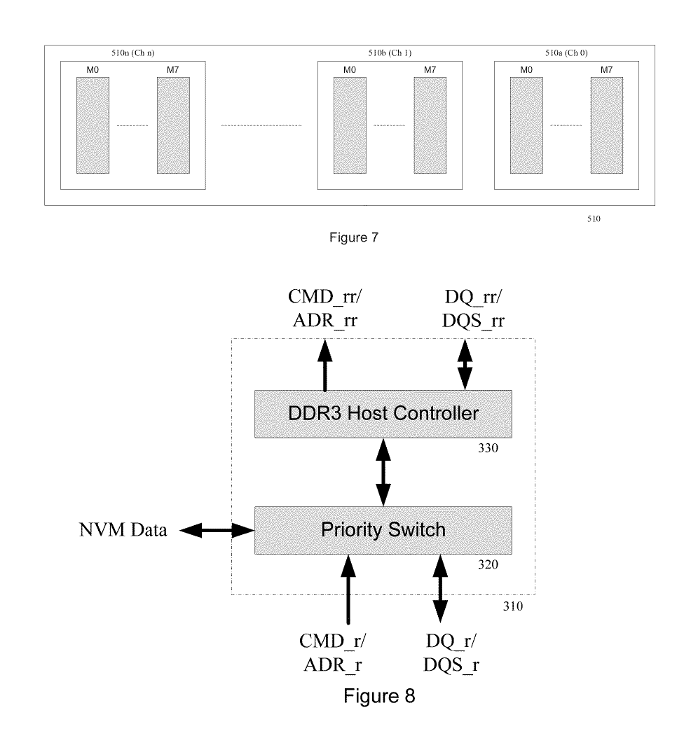

Referring to FIG. 7, a block diagram of the nonvolatile memory system 510 is shown. The module is coupled to the rest of the storage system via the channel processor 240.

The NVM system 510 includes a plurality of NVM modules (510a, 510b, . . . , 510n). Each NVM module includes a plurality of nonvolatile memory dies or chips. The NVM may be one of a Flash Memory, Phase Change Memory (PCM), Ovonic Universal Memory (OUM), and Magnetoresistive RAM (MRAM). Each NVM module may be in the form factor of a DIMM.

Referring to FIG. 8, a block diagram of the data interconnect module 310 is shown. The data interconnect module 310 is coupled to the BIU 110, the command processor module 210, and the media processor 220. The module is also coupled to a plurality of NVM modules 510 and to the DRAM modules 410. The DRAM modules 410 may include a plurality of DDR3 SDRAM, and DDR4 SDRAM memory modules. The data interconnect module 310 includes at least one host memory interface controller. The module works as a switch to transfer data between NVM module 510 and the DRAM modules 410, and between the DRAM modules 410 and the system memory controller. The data transfer between NVM module 510 and the DRAM module 410 is a background process, which shall pause when the system memory controller accesses the DRAM module 410.

Referring to FIG. 9, a block diagram of a SATA SSD on a DIMM is shown, which is an embodiment of the SSD system 100. The BIU 110, the storage controller 210, and the data interconnect module 310 are integrated in an ASIC 610. The SSD appears to the system as an AHCI device and is accessed through the AHCI/SATA storage device stack, supported in nearly all client platforms by a standard in-box device driver.

The complete set of registers exposed by an AHCI Host Bus Adapter (HBA) interface are described in the SATA AHCI specification, and not duplicated here. Some key registers are;
Capabilities registers—Describe support for optional features of the AHCI interface as well as optional features of the attached SATA devices.
Configuration registers—Allow the host to configure the HBA's operational modes,
Status registers—These registers report on such things as pending interrupts, timeout values, interrupt/command coalescing and HBA readiness.

AHCI implements the concept of ports. A port is a portal through which a SATA attached device has its interface exposed to the host and allows host direct or indirect access depending on the operational mode of the AHCI HBA. Each port has an associated set of registers that are duplicated across all ports. Up to a maximum of 32 ports may be implemented. Port registers provide the low level mechanisms through which the host access attached SATA devices. Port registers contain primarily either address descriptors or attached SATA device status. In this invention, all the PHY layer, link layer, and transport layer logic of the HBA and SATA ports have been removed to shorten the system access time to the SSD. Each NVM module in 510 can be optionally configured as a SATA device attached to the AHCI controller

As shown in FIG. 9, all the AHCI registers and port registers are mapped to the DRAM module 410 address domain as non-cacheable memory. The base address of the DRAM module 410 may be stored in the SPD (serial presence detect) of the DRAM module or dynamically detected by the AHCI device driver.

Issuance of a command to the SSD system 100 is a matter of constructing the command, staging it within an area of the DRAM module 410 and then notifying the AHCI controller 110 that it has commands staged and ready to be sent to the storage controller 210. The memory for each port's Command List is allocated statically due to the fact that AHCI registers must be initialized with the base address of the Command List. The data transfer related commands may have a Physical Region Descriptor (PRD) table which is a data structure used by DMA engines to describe memory regions for transferring data to/from the SSD 100. It is an entry in a scatter/gather list. Since the DMA engine inside the storage controller 210 of the SSD can not directly access the system memory other than DRAM module 410, it is required to allocate the system memory associated to the PRD table inside the DRAM module 410 address space.

Command completion is provided through mechanisms and constructs that are built on the SATA protocols. On command completion the storage controller 210 returns a Device-to-Host Frame Information Structure (FIS). Additional FIS types may play a role in command completion depending on the type of command that was issued and how it was relayed to the SSD 110. Regardless of the FIS types used, the purpose of the completion FIS is to communicate command completion status as well as to update overall device status. The return status FIS is contained within the DRAM module 410 based table termed the Received FIS Structure. At the time the host initializes the AHCI controller inside BIU 110 it will allocate host memory space inside the DRAM module 410 for the purpose of accepting received device FIS information. Each port of an adaptor has its own area of host memory reserved for this purpose.

Notification of command completion can be via interrupt or polling. The AHCI controller inside BIU 110 may be configured to generate an interrupt on command completion or the host may choose to poll the port's Command Issue register and, if the command is a NCQ command, the Serial ATA Active registers. If the host chooses to be notified of command completion via interrupts, then on interruption the host will have to read the contents of three, possibly four, controller registers. The host will have to read the AHCI controller's interrupt status register to determine which port has caused the interrupt, read the port interrupt status register to discover the reason for the interrupt, read the port's Command Issue register to determine which command has completed and finally, if the command is an NCQ command, read the port's Serial ATA Active register to determine the TAG for the queued command. A new pin or the EVENT# pin on the DIMM may be used to generate interrupt to the system.

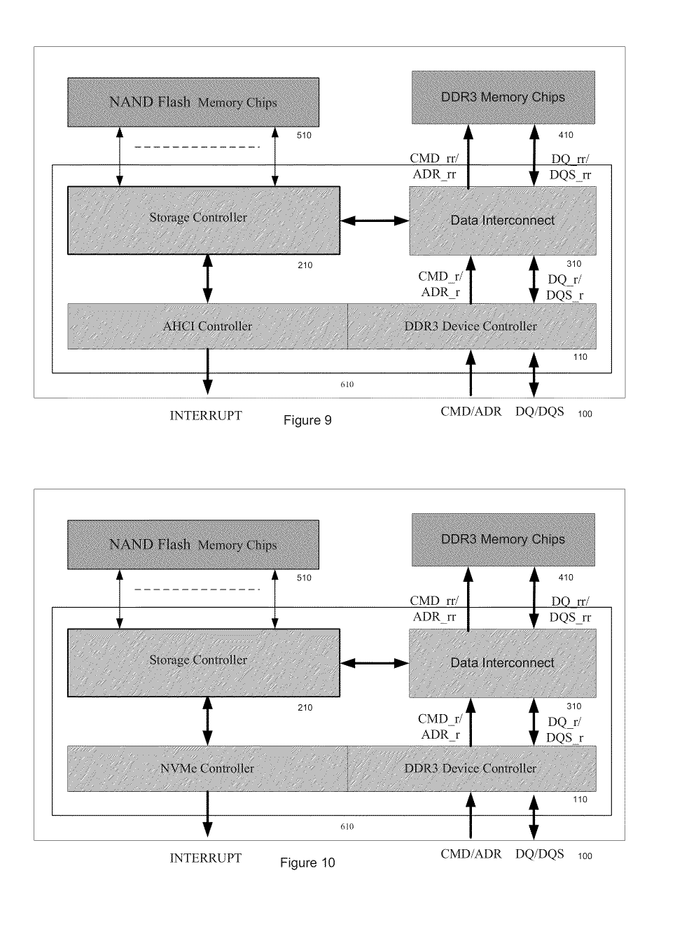

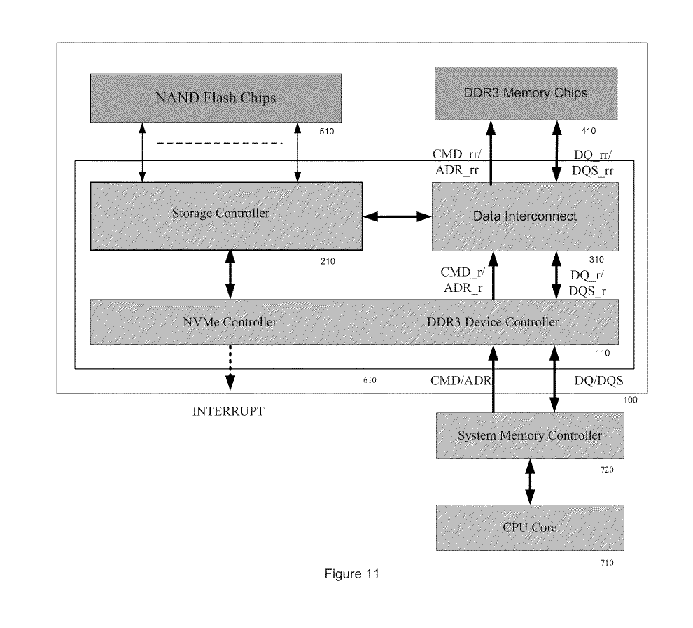

Referring to FIG. 10, a block diagram of an NVMe SSD on a DIMM is shown, which is another embodiment of the SSD system 100. The SSD appears to the system as an NVMe device and is accessed through the NVMe storage device stack.

The most significant difference between AHCI and NVMe is in the performance goals of the two interfaces. NVMe was architected from the ground up to provide the most bandwidth and lowest latency possible with today's systems and devices. While performance was important to AHCI, it was in the context of SATA HDDs which do not place the same demands on the surrounding infrastructure and support matrix as PCIe SSDs. The main differences in the two interfaces are listed as following:
NVMe is designed as an end point device interface, while AHCI is designed as an aggregation point that also serves to translate between the protocols of two different transports, PCI and SATA, which have been removed from this invention.
NVMe can support up to 64K command submission completion queue pairs. It can also support multiple command submission queues where command completion status is placed on a command completion queue. AHCI however provides this functionality as a means of allowing a host adaptor (HBA) to serve as an effective fan-out connection point to up to 32 end devices.
Each NVMe command queue supports 64K command entries, and each AHCI port supports 32 command queue depth.
AHCI has a single interrupt to the host versus the support for an interrupt per completion queue of NVMe. The single interrupt of AHCI is adequate for the subsystem it is designed for. The multiple interrupt capability of NVMe allows for the platform to partition compute resources in a way that is most efficient for rapid command completion, i.e. dedicated cores, threads.

NVMe as an interface to devices that have extremely low latency and high bandwidth characteristics has endeavored to enable the full benefit of the device to be realized by the system in which they are used. Efficiency in the transfer of commands and status was made a top priority in the interface design. Parallelism in the interface was also a priority so that the highly parallel systems of today could take full advantage of multiple concurrent IO paths all the way down to the device itself. Add a system memory controller 720 and a CPU core 710 to the storage system as shown in FIG. 11 can improve the SSD system performance and scalability. The CPU core 710 can help the NVMe SSD system to achieve MSI or MSI-X interrupt mechanism. When data moves from the NAND Flash module 510 to the DDR3/DDR4 memory module 410 which is mapped to a cacheable memory space, the system may not know the data update and cause memory coherence problem. To solve the memory coherence problem, the CPU core 710 checks each completion queue to see if a data buffer with new read data from the NAND Flash module 510, it may notify the associated CPU to flush its cache or pre-fetch the new read data.

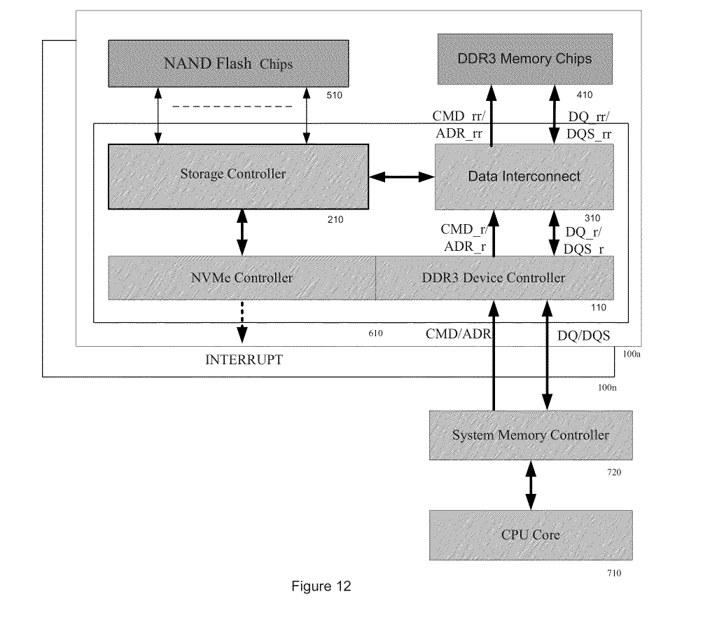

Referring to FIG. 12, a block diagram of a SSD system with multiple NVMe DIMMs is shown, which is another embodiment of the SSD system 100. As shown in FIG. 11, a system memory controller 720 and a CPU core 710 manage the SSD system to achieve desired system performance and provide support for a fault tolerant implementation and enhance the ability of the SSD system.

### Other Embodiments

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, while particular architectures are set forth with respect to the SSD system and the SSD host interface unit, it will be appreciated that variations within these architectures are within the scope of the present invention. Also, while particular storage command flow descriptions are set forth, it will be appreciated that variations within the storage command flow are within the scope of the present invention.

Also for example, the above-discussed embodiments include modules and units that perform certain tasks. The modules and units discussed herein may include hardware modules or software modules. The hardware modules may be implemented within custom circuitry or via some form of programmable logic device. The software modules may include script, batch, or other executable files. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules and units is for illustrative purposes. Alternative embodiments may merge the functionality of multiple modules or units into a single module or unit or may impose an alternate decomposition of functionality of modules or units. For example, a software module for calling sub-modules may be decomposed so that each sub-module performs its function and passes control directly to another sub-module.

Consequently, the invention is intended to be limited only the spirit and scope of the appended claims, giving full cognizance to equivalents in all respects.

1. A SSD system directly connected to the system memory bus comprising: at least one system memory bus interface unit (BIU), one storage controller, one data interconnect unit (DIU), one DRAM module, one nonvolatile memory (NVM) module, and flexible association between AHCI/NVMe commands and the NVM module.

2. The system memory bus interface of claim 1 includes a DDR3/DDR4 memory bus interface.

3. The BIU of claim 1 includes an AHCI controller or an NVMe controller.

4. The storage controller of claim 1 performs a programmable classification on a plurality of AHCI/NVMe command queues, terminates all the AHCI/NVMe commands other than NVM read and write commands, and converts the SSD logical block address (LBA) to physical address (PA) and vise versa.

5. The storage controller of claim 1 manages the functions of wear leveling, bad block table, and garbage collection of the SSD.

6. The storage controller of claim 1 generates ECC parity for the write data, and correct data errors with the parity for the corresponding read data.

7. The storage controller of claim 1 randomizes the write data, and de-randomizes the corresponding read data.

8. The storage controller of claim 1 controls the NVM interface timing, and access command sequences.

9. The DRAM module of claim 1 composes DDR3 DRAM, or DDR4 DRAM.

10. The DRAM module of claim 1 is mapped to the system memory domain, and is accessible by both the system memory controller and the storage controller of claim 1.

11. The DRAM module of claim 1 appears to the system memory controller as an UDIMM with additional latency (AL) of 1 or 2 memory clock cycles.

12. The lower N*4KB address space of the DRAM module of claim 1 appears to the system as a memory mapped IO (MMIO) space. The N is application specific. The rest of DRAM module memory address space appears to the system as cacheable memory space.

13. The DIU of claim 1 works as a switch to transfer data between the NVM module and the DRAM module, and between the DRAM module and the system memory controller.

14. In the DIU of claim 1, data transfer between the NVM module and the DRAM module is a background process, which shall pause when the system memory controller accesses the DRAM module.

15. The NVM of claim 1 is but not limited to NAND flash memory, and phase change memory.

16. The NVM modules and the DRAM modules of claim 1 have proprietary pinouts or any one of the standard JEDEC memory module pinouts to plug into the computer system dual in-line memory module (DIMM) sockets.

17. The SSD system of claim 1 is in a single DIMM socket or in a plurality of DIMM sockets.

18. The computer system programs the SSD system of claim 1 as an AHCI device or an NVMe device.

19. The SSD system of claim 1 has at least one interrupt connection to the system to report events to the system CPU.

20. The method of claim 1 wherein the flexible association between AHCI/NVMe commands and the NVM module is provided via the storage controller using both hardware and firmware.
